(19) United States
(12) Patent Application Publication
(10) Pub. No.: US 2003/0162161 A1
(43) Pub. Date: Aug. 28, 2003

(54) Interactive puzzle

(75) Inventor: Jack Horchler, Frankfort, IL (US)

Correspondence Address: MICHAEL BEST & FRIEDRICH LLC, Suite 1900, 401 North Michigan Avenue, Chicago, IL, 60611, US

(73) Assignee: Tek Nek Toys International, Inc., Mokena, IL (US)

(21) Appl. No.: 10/364,138

(22) Filed: Feb. 11, 2003

Related U.S. Application Data
(60) Provisional application No. 60/359,855, filed on Feb. 27, 2002.

(51) Int. Cl. G09B 25/00

(52) U.S. Cl. 434/406

(57) ABSTRACT

The invention provides an interactive, electronic, puzzle for amusing and creatively stimulating children. The interactive puzzle includes a tray that accepts puzzle pieces. Each of the puzzle pieces is shaped or marked to correspond to a concept in a unifying theme, such as a nursery rhyme. The tray includes sensors that cooperate with actuators located on the undersides of the puzzle pieces. When a puzzle piece is oriented properly in the tray, the puzzle piece actuates a predetermined sensor to trigger a predetermined audio response as a reward. The audio response can be a song, a story, a poem, a character, an object or an event referenced in a nursery rhyme.

### RELATED APPLICATION

The present application claims the benefit of co-pending U.S. provisional patent application Serial No. 60/359,855, filed Feb. 27, 2002, and U.S. traditional patent application Ser. No. 10/334,641, filed Dec. 31, 2002. Both of these applications are incorporated by reference in their entirety and, specifically, for their teachings regarding interactive puzzles.

### TECHNICAL FIELD

This invention relates generally to educational toys. More specifically, the invention relates to a puzzle for assembly by children and to interactive electronic learning devices.

### BACKGROUND OF THE INVENTION

The importance of a child's first learning experiences can hardly be overstated. In many cases, a child is initially exposed to poetry, literature and song in the form of nursery rhymes. For centuries, nursery rhymes have been a mainstay of preschool and primary education. Nursery rhymes have traditionally been passed to each new generation by tedious oral repetition, and each new generation has initially learned them by rote. The nursery rhyme provides a unifying theme for various words and concepts, which the child may commit to memory.

Children love to hear the same story, rhyme or song over and over, and they benefit from serial repetition. Parents and other caregivers tire easily of this repetition, but traditionally have endured the tedium so as to be present at those moments when the child is susceptible to more advanced learning. A need exists for a learning device that assists very young children to learn nursery rhymes and to establish a correspondence between the words of the nursery rhymes and the concepts represented by the words.

Puzzles with pieces that fit into corresponding trays may be employed to teach themes, such as nursery rhymes, and such puzzles have been previously publicized. However, very young children do not typically possess the motor skills to place each piece in a corresponding tray.

Electronic jigsaw puzzles may be utilized as learning devices, but jigsaw puzzles do not emphasize the importance of any particular piece or concept in a larger theme. Additionally, the rather complicated process of solving an entire jigsaw puzzle can take longer than the attention span of young children will permit. This shortcoming is exacerbated by electronic jigsaw puzzles that require the child to complete the entire puzzle in order to receive a reward.

Consequently, a need exists for an interactive educational toy that makes it fun for a child to learn nursery rhymes, songs or other subjects or unifying themes and that helps the child understand their meaning. The new toy should include enough information to challenge the child. The new toy should focus the child's attention on the nursery rhyme, song or other theme and reward the child immediately when he or she correctly identifies a concept related to the theme. It would be desirable for the new toy to engage the child with simultaneous sight, sound and tactile experiences to stimulate the child's memory and promote recall of the learned information.

### SUMMARY OF THE INVENTION

The invention is an interactive, electronic puzzle that makes it fun for a child to learn information by memorization and to understand the meaning of the information. The puzzle includes distinctively-shaped puzzle pieces including actuating elements, a form-fitting puzzle tray equipped with sensors, and a microprocessor for determining which sensors are actuated and for sending appropriate audio responses to a speaker. The puzzle pieces are shaped or colored to represent concepts related to a unifying theme of interest to the child. Placing each puzzle piece in its predetermined position in the tray actuates one of the sensors and triggers a dedicated audio response as a reward for the child. The audio response immediately follows correct placement of each puzzle piece. Additionally, the puzzle includes an actuator for playing a song or a story so that the child may enjoy the song or story and refresh his or her memory at any time.

The invention can be played with puzzle pieces that are each shaped or marked to symbolize a concept. The sensors may be actuated, for example, by mechanical pressure, magnetism, or electrical induction. The sensors are located on or near the receiving surface. Each of the sensors is positioned for actuation by one of the actuating elements when the piece including that actuating element is placed against the receiving surface in a predetermined relationship with respect to the sensors. The interactive puzzle includes means for identifying each sensor that is actuated, such as a microprocessor that is electrically connected to the sensors. The interactive puzzle also has means for means for playing, upon actuation of each sensor, an audio response dedicated to that actuated sensor.

The tray may include a raised edge that is sized and shaped to fit around all of the pieces, when each of the pieces is received by one of the receptacles and positioned against the receiving surface in the predetermined relationship. The audio responses may include information that is related to the unifying theme, which may be a song, a story, a poem, a fictional character, or an object or event. Areas may be marked on the receiving surface in the shape of particular puzzle pieces to assist the child in finding the predetermined positions for the puzzle pieces.

In another form of the invention, the tray has a raised edge that is sized and shaped to fit around all of the puzzle pieces when they are arranged in jigsaw fashion. The puzzle pieces have topsides, and at least some of the topsides are sculptured or colored to communicate a concept related to a unifying theme, such as a song, a story or a nursery rhyme. The sensors are pushbutton switches. The microprocessor includes a microchip that is capable of sensing voltage changes that occur when the sensors are actuated. Various audio responses can be sent by the microprocessor to the speaker, depending on which of the sensors is actuated.

The invention is also a method for using the interactive puzzle. In the method, a child or other user places one of the puzzle pieces against the receiving surface in its predetermined position with respect to the receptacles. The child may fit the puzzle pieces against the raised edge of the tray as a guide and may compare the shapes of the demarcated areas with the shapes of the puzzle pieces in order to determine where each of the puzzle pieces belongs. Pressing the puzzle piece against the receiving surface while the puzzle piece is in its predetermined position actuates the corresponding sensor and triggers an appropriate audio response, which, where desired, may relate to a unifying theme.

### BRIEF DESCRIPTION OF THE DRAWINGS

FIG. 1 is a plan view of an interactive electronic puzzle of the present invention, including puzzle pieces and a tray;

FIG. 2 is a side elevation view of the puzzle depicted in FIG. 1, showing the puzzle pieces and the tray mounted on a base;

FIG. 3 is a plan view of the tray of FIG. 1;

FIG. 4 is a plan view of two of the puzzle pieces depicted in FIG. 1;

FIG. 5 is a perspective view showing projections formed by the undersides of the puzzle pieces depicted in FIG. 4;

FIG. 6 is a perspective view depicting the tray and base unfastened from each other and separated to illustrate internal components;

FIG. 7 is a close-up, partial perspective view of the base, including several sensors in assembled form and one sensor in disassembled form;

FIG. 8 is a close-up, partial perspective view of the base, including a microprocessor and a microchip; and

FIG. 9 is a close-up partial perspective view of the base depicting the actuator in disassembled form.

### DETAILED DESCRIPTION OF PREFERRED EMBODIMENTS

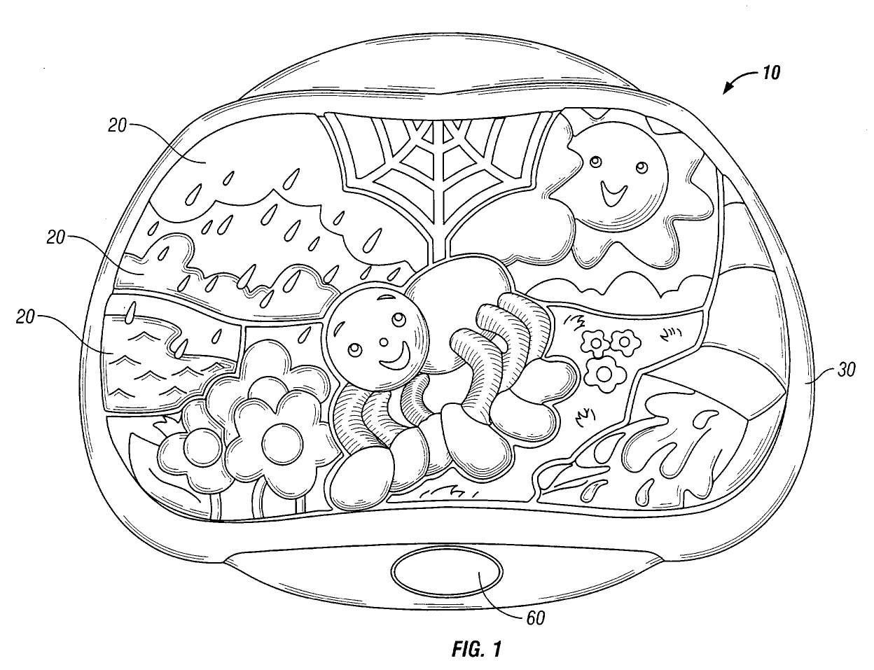

In a preferred embodiment, the invention is an interactive, electronic puzzle 10 for amusing and creatively stimulating children. As depicted in FIG. 1, puzzle 10 includes puzzle pieces 20 corresponding to particular concepts in a unifying theme or motif that helps the child to associate and understand the concepts. For puzzle 10, the disclosed unifying theme is a nursery rhyme entitled “The Itsy Bitsy Spider.” Other nursery rhymes suitable for use in the invention include, for example, “Twinkle, Twinkle, Little Star”; “Mary Had a Little Lamb”; “Jack and Jill Went Up the Hill”; “Row, Row, Row Your Boat”; and “Old McDonald Had a Farm,” to name just a few.

Beginning at the top of puzzle 10 and continuing in a clockwise direction, particular puzzle pieces 20 are shown corresponding to a spider web, the sun, water, flowers, a spider, the fragrance of flowers, a puddle and rain. These are concepts referenced in “The Itsy Bitsy Spider.” Puzzle 10 also includes an interactive tray 30 and an actuator 60 for playing the nursery rhyme.

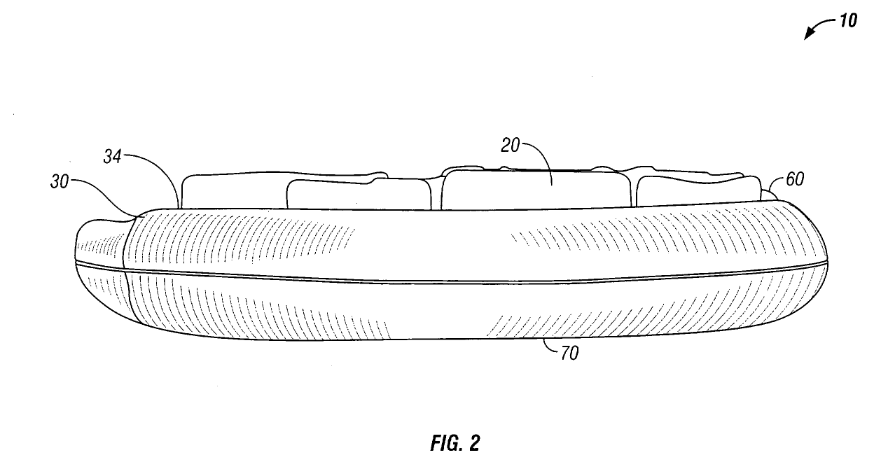

FIG. 2 depicts tray 30 with raised edge 34, which is sized and shaped to fit around all of the puzzle pieces 20 when they are arranged in predetermined positions with respect to each other. Actuator 60 is located on tray 30 and outside of edge 34. Tray 30 is mounted on base 70.

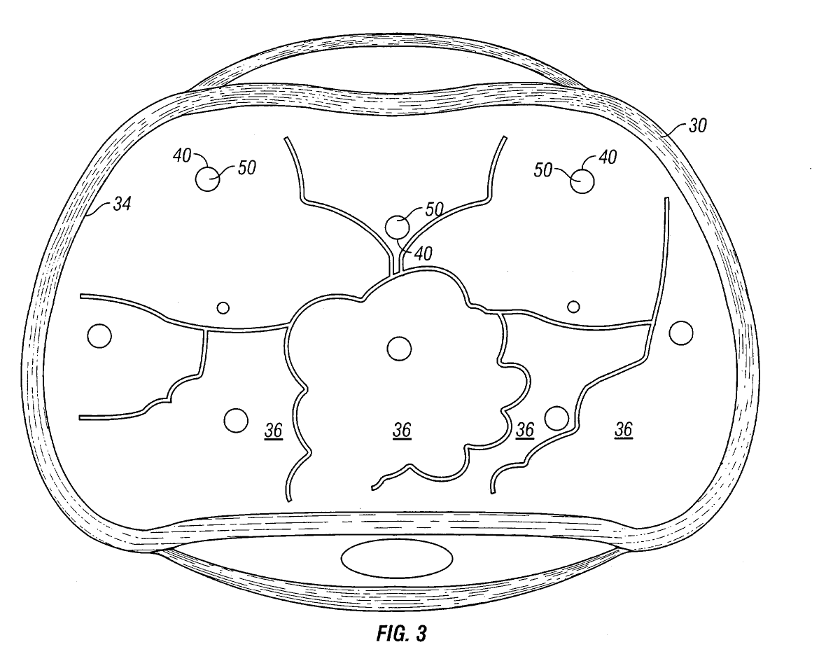

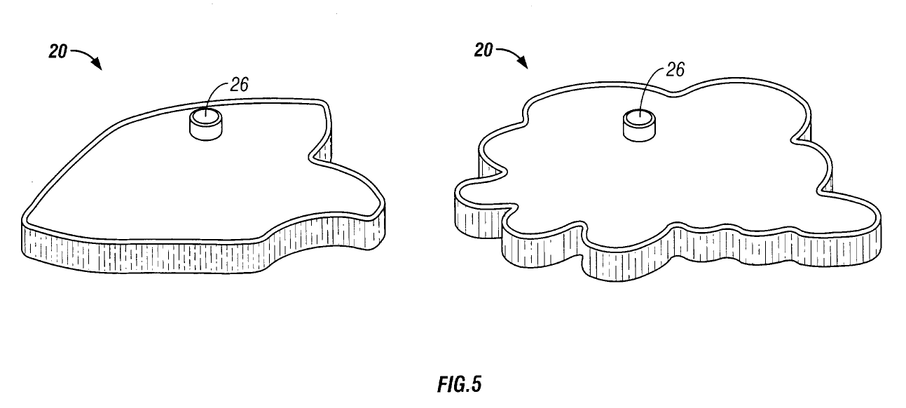

Turning now to FIG. 3, recessed receptacles 40 are positioned at irregular intervals along receiving surface 32. Receptacles 40 are located at or below receiving surface 32. Each of the receptacles 40 houses a sensor 50 for actuating by one of the projections 26 (best seen in FIG. 5). Adjacent each of the sensors 50 is a demarcated area 36 having the same shape as one of the puzzle pieces 20. The child may use the areas 36 as guides for determining which of the puzzle pieces 20 corresponds to the adjacent sensor 50.

In other embodiments (not shown) of the present invention, tray projections are positioned along a receiving surface, for cooperating with piece receptacles on each of a plurality of puzzle pieces.

Comparing FIGS. 1 and 3, puzzle pieces 20 are shaped to mate with each other in a predetermined arrangement having a shape and size appropriate to fit inside raised edge 34. When one of the puzzle pieces 20 is placed in its predetermined position with respect to receptacles 40 and pressed against receiving surface 34, projection 26 of that puzzle piece 20 enters the appropriate receptacle 40 and actuates the sensor 50 within the receptacle.

In other embodiments (not shown), it is contemplated that each of a plurality of puzzle pieces contains an actuating element for cooperation with a sensor located in or on a tray. In those embodiments (not shown), the actuating elements may actuate the sensors by mechanical pressure, magnetism, or electrical voltage or current.

Preferably, each of the puzzle pieces 20 has a boundary surface that fits against raised edge 34 while its projection 26 is in the corresponding receptacle 40 that can trigger an appropriate audio response. This fit between raised edge 34 and each of puzzle pieces 20 makes puzzle 10 easier to solve and reduces the number of false positive audio responses. Although it may be possible to insert one of the puzzle pieces 20 into more than one of the receptacles 40, even a very young child soon comes to appreciate that each puzzle piece 20 fits with raised edge 34 in the predetermined position. For the present purposes, puzzle pieces 20 are fitted together in jigsaw fashion when all of the puzzle pieces 20 are placed in their predetermined positions with respect to each other.

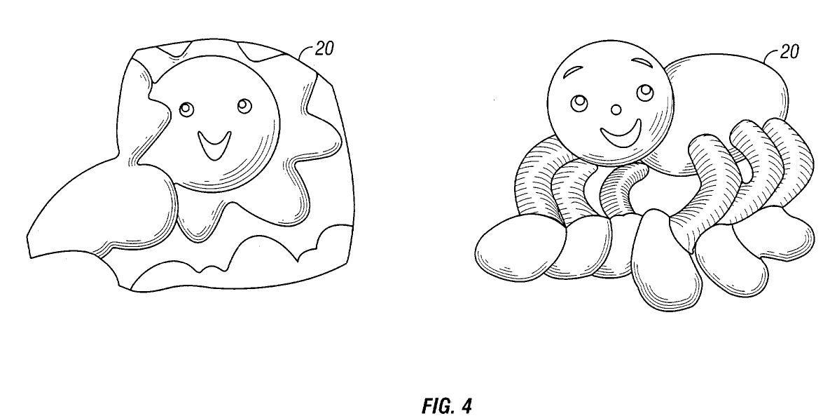

Each piece 20 is shaped or marked to symbolize a concept related to the unifying theme. For example, the puzzle pieces 20 depicted in FIG. 4 symbolize the sun and The Itsy Bitsy Spider, respectively. Each of these puzzle pieces 20 has a top side that is sculptured and colored to reflect the symbolized concept, which relates to the unifying theme. As shown in FIG. 5, each of the puzzle pieces 20 includes an underside that forms a projection 26 for inserting into one of the receptacles 40.

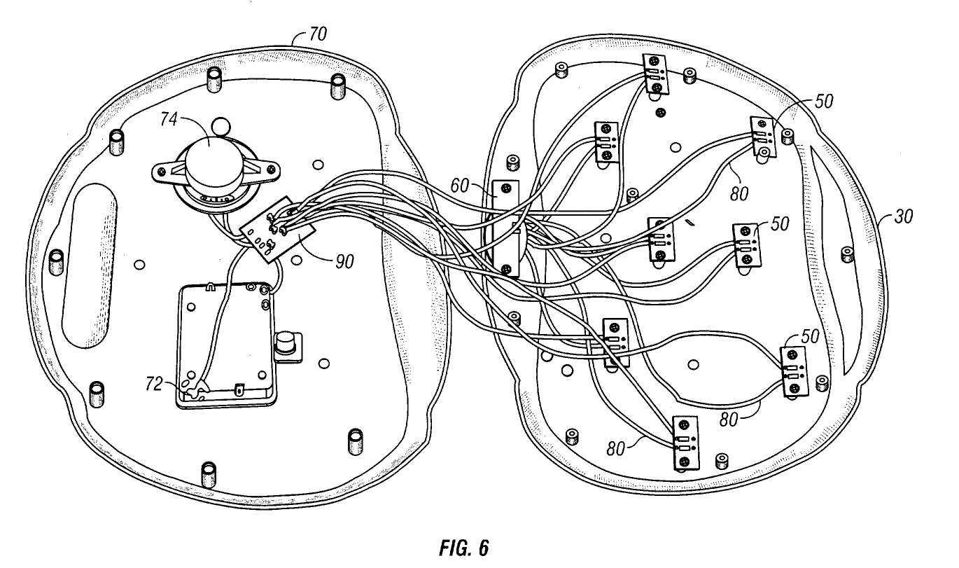

FIG. 6 shows tray 30 separated from base 70 in order to illustrate various internal components. Base 70 includes battery compartment 72, preferably sized for housing three 1.5-volt AA-size batteries (not shown), and speaker 74, each electrically connected to microprocessor 90. Additionally, electrical conductors 80 electrically connect each of the sensors 50 and actuator 60 to microprocessor 90.

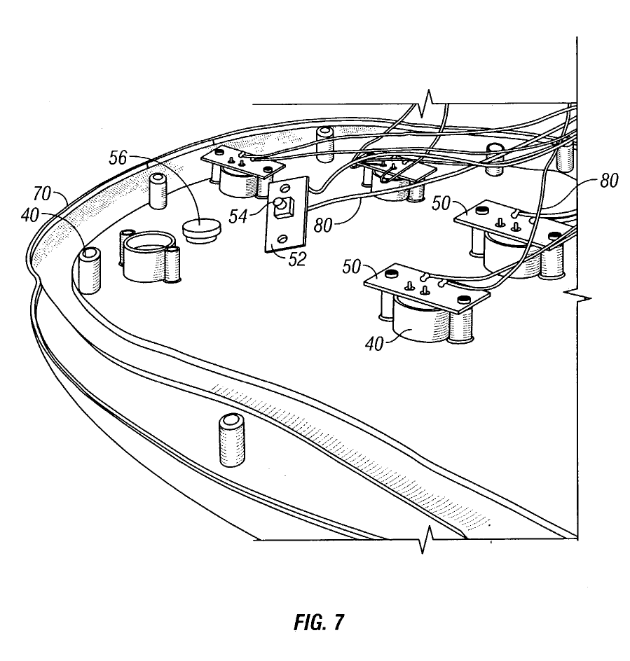

FIG. 7 is a close-up view of base 70, which depicts several of the sensors 50, inserted in receptacles 40 and electrically connected to an electrical conductor 80. One of the sensors 50 is disassembled, showing that it includes a mounting board 52, a pushbutton switch 54 and a pushbutton 56. When sensor 50 is assembled, depressing pushbutton 56 causes pushbutton switch 54 to close a normally open electrical contact, which produces an identifiable voltage change in one of the electrical conductors 80. Microprocessor 90 is capable of detecting this change in voltage and determining which one of the sensors 50 has produced the voltage change. Based on the voltage change, microprocessor 90 sends to speaker 74 an audio response appropriate for the particular sensor 50. As a result, the child is immediately rewarded by this audio response for his or her part in depressing pushbutton 56.

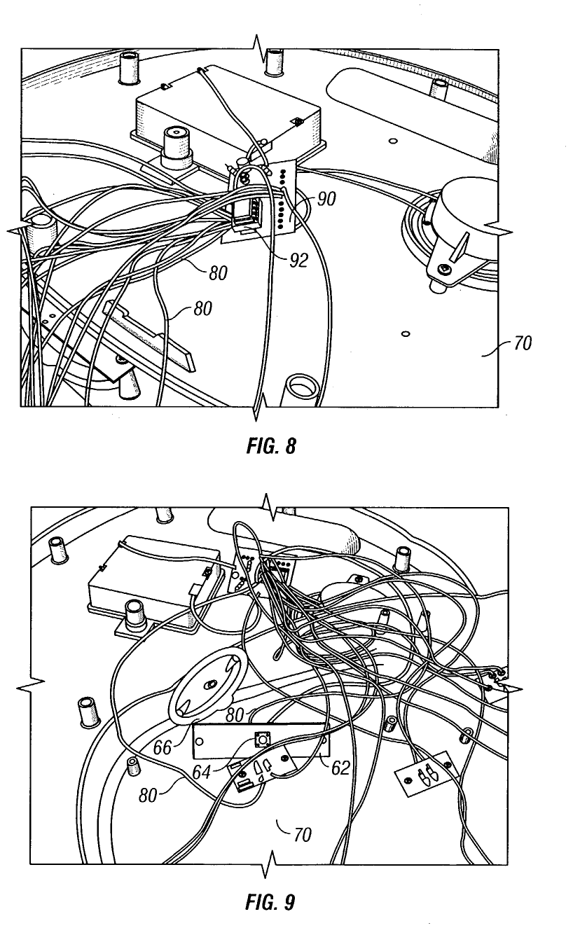

Microprocessor 90 is depicted in FIG. 8, which is another close-up perspective view of base 70. Microprocessor 90 includes microchip 92 seated on a chip carrier and electrically connected to, among other things, electrical conductors 80.

FIG. 9 is another close-up perspective view of base 70, this time depicting actuator 60 in disassembled form. As can be seen in FIG. 9, actuator 60 includes mounting board 62, pushbutton switch 64 and pushbutton 60. A direct current voltage from the batteries (not shown) is impressed on each of the electrical conductors 80. Each of the sensors 50 include a pushbutton switch 54 having a normally open contact (not shown). One side of the contact is electrically connected to one of the electrical conductors 80. The other side of the contact is electrically connected to a ground. Microprocessor 90 monitors the voltage between each of the electrical conductors 80 and the ground. At least one of these voltages changes when one of the sensors 50 is activated. Based on this change in voltage, microprocessor 90 sends a recorded message or other audio response to speaker 74. The audio response is appropriate for the concept associated with the particular sensor 50.

In order to use the interactive puzzle of the present invention, a child places one of the puzzle pieces against the receiving surface in its predetermined position with respect to the receptacles. The child may fit the puzzle pieces against the raised edge of the tray as a guide and compare the shapes of the demarcated areas with the shapes of the puzzle pieces in order to determine where each of the puzzle pieces belongs. Pressing the puzzle piece against the receiving surface while the puzzle piece is in its predetermined position actuates the corresponding sensor and triggers an appropriate audio response related to the unifying theme. The child may also press the actuator, which, when a unifying these (such as a nursery rhyme) is employed, causes a synopsis of the unifying theme to be played in its entirety, in order to refresh the child's memory or to simply enjoy the theme. The theme may be in the form of a song, story, poem or nursery rhyme.

By solving the interactive puzzle of the invention, children learn words, songs, nursery rhymes, concepts, the relationships between the words and concepts, or other subject matter. The puzzle of this invention may be solved repeatedly, and an audio response immediately rewards each success.

While only a few, preferred embodiments of the invention have been described above, those of ordinary skill in the art will recognize that these embodiments may be modified and altered without departing from the central spirit and scope of the invention. The preferred embodiments described above are to be considered in all respects as illustrative and not restrictive.

That which is claimed is:

1. An interactive puzzle, which comprises:
a plurality of distinctively shaped pieces, each of the pieces including an actuating element and being shaped or marked to symbolize a concept;
a tray having a receiving surface;
a plurality of sensors, each of the sensors located adjacent the receiving surface and positioned for actuation by one of the actuating elements when the piece including that actuating element is placed against the receiving surface in a predetermined relationship with respect to the sensors;
means for identifying each sensor that is actuated; and
means for playing, upon actuation of each sensor, an audio response dedicated to the actuated sensor.

2. The puzzle of claim 1 in which the tray includes a raised edge that is sized and shaped to fit around all of the pieces, when each of the pieces is positioned against the receiving surface in the predetermined relationship.

3. The puzzle of claim 1 in which the audio responses include information and are selected from the group consisting of a song, a story, a poem, a character, and an object or event referenced in a nursery rhyme.

4. The puzzle of claim 3 in which a nursery rhyme and the audio responses include information relating to the nursery rhyme.

5. The puzzle of claim 1 in which a nursery rhyme and the puzzle includes an actuator for playing the nursery rhyme.

6. The puzzle of claim 1 in which dedicated areas of the receiving surface are demarcated adjacent each of the sensors, and each of the areas is shaped or marked to symbolize a concept.

7. The puzzle of claim 6 in which the pieces fit together in jigsaw fashion.

8. The puzzle of claim 7 in which the sensors are located at or below the receiving surface.

9. The puzzle of claim 8 in which the actuating elements are projections, each of the projections extending from the underside of one of the pieces respectively.

10. An interactive puzzle having a unifying theme, which comprises:
a plurality of distinctively shaped pieces, each of the pieces having an underside that forms a projection or a receptacle, and each of the pieces shaped or marked to symbolize a concept related to a unifying theme;
a tray having a receiving surface that includes projections or receptacles, each of the tray projections or tray receptacles positioned to cooperate with one of the piece projections or piece receptacles when the piece that forms the piece projection or the piece receptacle is placed against the receiving surface in a predetermined relationship with respect to the receptacles;
a plurality of sensors, each of the sensors located in or on the tray for actuating by the piece projections or the piece receptacles;
means for determining whether and which one of the sensors is actuated; and
means for playing, upon actuation of each of the sensors, an audio response dedicated to the actuated sensor and related to the unifying theme.

11. The puzzle of claim 10 in which the tray includes a raised edge sized and shaped to fit around all of the pieces, when each of the pieces is positioned against the receiving surface in the predetermined relationship.

12. The puzzle of claim 10 in which the audio responses include information selected from the group consisting of a song, a story, a poem, a character, and an object or event referenced in a nursery rhyme.

13. The puzzle of claim 12 in which the unifying theme is a nursery rhyme, and the audio responses include information relating to the nursery rhyme.

14. The puzzle of claim 10 in which the unifying theme is a nursery rhyme and the puzzle includes an actuator for playing the nursery rhyme.

15. The puzzle of claim 10 in which dedicated areas of the receiving surface are demarcated adjacent each of the tray projections or the tray receptacles, and each of the areas is shaped or marked to symbolize a concept related to the unifying theme.

16. The puzzle of claim 10 in which the pieces fit in jigsaw fashion.

17. The puzzle of claim 10 in which each of the sensors is located at or below the receiving surface in one of the tray receptacles.

18. An interactive puzzle, which comprises:
a plurality of distinctively shaped pieces, each of the pieces having an underside that forms a projection, each of the pieces adapted to symbolize a concept and shaped to fit with the other pieces in jigsaw fashion;
one and only one undivided tray having a receiving surface and an edge sized and shaped to fit around all of the pieces when they are arranged in jigsaw fashion, the receiving surface forming a plurality of recessed receptacles, each of the receptacles positioned to receive one of the projections when the pieces are arranged in jigsaw fashion on the receiving surface;
a plurality of sensors for actuation by the projections, each of the sensors located in one of the receptacles;
means for determining whether and which one of the sensors is actuated; and
means for playing, upon actuation of each of the sensors, an audio response dedicated to the actuated sensor and including information relating to the unifying theme.

19. The puzzle of claim 18 in which the information is selected from the group consisting of a song, a story, a poem, a character, and an object or event referenced in a nursery rhyme.

20. The puzzle of claim 18 including an actuator for playing a nursery rhyme.

21. The puzzle of claim 20 in which the actuator is a pushbutton switch.

22. The puzzle of claim 18 in which dedicated areas of the receiving surface are demarcated adjacent at least some of the receptacles, and each of the areas is shaped or marked to symbolize a concept.

23. The puzzle of claim 22 in which the information is selected from the group consisting of a song, a story, a poem, a character, and an or event object referenced in a nursery rhyme.

24. The puzzle of claim 18 in which the pieces have topsides, and at least some of the topsides are sculptured or colored to communicate the concept symbolized by the piece.

25. The puzzle of claim 18 in which the sensors are pushbutton switches.

26. The puzzle of claim 18 in which actuating one of the sensors completes an electrical circuit that is associated with that sensor.

27. The puzzle of claim 18 including a speaker for playing the audio responses and a microprocessor; and in which actuating each one of the sensors causes an identifiable voltage change in one of a plurality of electrical conductors and the microprocessor is capable of detecting the voltage change, determining which one of the sensors is associated with the voltage change and sending to the speaker the audio response dedicated to the associated sensor.

28. A method of using an interactive puzzle, which method comprises:
providing an interactive puzzle that includes
a plurality of distinctively shaped pieces, each of the pieces having an underside that forms a projection, and each of the pieces shaped or marked to symbolize a concept;
a tray having a receiving surface that includes receptacles, each of the receptacles positioned to receive one of the projections when the piece that forms the projection is placed against the receiving surface in a predetermined relationship with respect to the receptacles;
a plurality of sensors, each of the sensors located in one of the receptacles for actuating by the projections; and
means for determining whether and which one of the sensors is actuated; and means for playing, upon actuation of each of the sensors, an audio response dedicated to the actuated sensor; and
placing one of the puzzle pieces against the receiving surface in a predetermined relationship with respect to the receptacles so as to actuate the dedicated audio response.

29. The method of claim 28, which also comprises pressing one of the pieces against the receiving surface so as to actuate the sensor.

30. The method of claim 28, which also comprises fitting one of the pieces against the raised edge.

31. The method of claim 28, which also comprises depressing an actuator located on the puzzle to play the nursery rhyme.
